(19) United States
(12) Patent Application Publication
(10) Pub. No.: US 2014/0186623 A1
(43) Pub. Date: Jul. 3, 2014

(54) A METHOD OF PREPARING METAL OXIDE MICROTUBES

(71) Applicants: Marko Part, Tartu (EE); Tanel Tätte, Tartu (EE); Uno Mäeorg, Tartu (EE); Valter Kiisk, Tartu (EE); Gunnar Nurk, Tartu (EE); Aleksei Vorobjov, Tartu (EE); Kelli Hanschmidt, Tartu (EE)

(72) Inventors: Marko Part, Tartu (EE); Tanel Tätte, Tartu (EE); Uno Mäeorg, Tartu (EE); Valter Kiisk, Tartu (EE); Gunnar Nurk, Tartu (EE); Aleksei Vorobjov, Tartu (EE); Kelli Hanschmidt, Tartu (EE)

(73) Assignee: UNIVERSITY OF TARTU, Tartu (EE)

(21) Appl. No.: 13/981,276

(22) PCT Filed: Dec. 31, 2011
(86) PCT No.: PCT/EP11/74333

§ 371 Date: Oct. 1, 2013

(30) Foreign Application Priority Data
Dec. 31, 2010 (EE) P201000097

(51) Int. Cl. C04B 35/624

(52) U.S. Cl. CPC C04B 35/624
USPC 428/398; 264/623

(57) ABSTRACT

The present invention prescribes a new sol-gel method of preparing and formation of the metal oxide microtubes. According to the method firstly is prepared the precursor sol from metal oxides or mixtures of metal oxides and alkoxides, thereafter from the precursor sol are extruded the fibres, which are gelatinised afterwards until the inner sol which is less viscous of fibres is converted to thinner wall until alcohol from the precursor is left trough walls. The metal oxide microtubes are applicable as to conduct liquids or gasses, as ionic conductors, as catalyst carriers and as light emitters.

### TECHNICAL FIELD

The object of the current invention is a sol-gel method for preparation of metal oxide ceramic microtubes. Tubes are applicable for pumping liquids and gasses under 0-10000 atm difference of pressure applied inside the tubes compared to pressure applied outside the tubes in temperature range from 2 to 2000 K, as construction materials, as nozzles to generate liquid droplets or jets, as ion-conducting membranes to separate electronically conductive materials from each other, as light emitters, as carriers of catalyst particles and as optical or electrical gas sensors. The tubes are synthesised from precursor materials based on metal alkoxide, which contains 0-50% of solvent. The precursor is transformed to jets in a gas or liquid environment. The tubes form as a result of chemical processes caused by the humidity of the environment.

### BACKGROUND ART

Several methods are proposed as prior art for preparation of 3-D ceramic micro-materials including microtubes. One of the methods, widely applied for preparation of micro tubular ceramic materials, is based on using organic or anorganic fibres, different membranes, ionic liquids [11] etc. as templates [1,2,3,4,5,6,7,8,9,10]. These templates are covered by a layer of ceramic materials by using sol-gel technology [5,12,13], coating of the surfaces by different mixtures of ceramic precursors [1,4], chemical vapour deposition (CVD) processes [15,16,17], laser deposition processes [1,8], thermal vapour deposition [1,9], layer by layer adsorption coating [20,21], electrophoretic deposition [22,23], hydrothermal deposition [24] or some other methods. The tubes are obtained when the template at the core of these structures is removed. This can be done by using burning, melting or dissolving of the template (FIG. 1). The weakness of the method is that it enables preparing materials with low structural homogeneity only. The method does not enable to obtain optically homogeneous materials. The size and shape of pores inside the final material depends on coating procedure, diameter of template fibre, thickness of ceramic coating on template and on coating method. As the removal of template could cause changes of its volume, unhomogenities and cracks could appear during the processing. Expensive technologies are needed when ceramic layer is carried onto the surface of template by using CVD, atomic layer deposition, laser deposition or thermal vapour deposition. Due to the unhomogeneous structure of the tubes obtained by template method they can only withstand 2-3 atm pressure differences applied between the inside and outside of the tubes.

Another known method for preparation of ceramic tubes is extrusion, which enables to prepare hollow ceramic materials by pressing viscous-elastic precursor materials into a suitable shape mold. The tubes can also be prepared by pressing the precursor trough a suitable shape nozzle. Solidification of precursor is achieved as a response to cooling, chemical reaction or chemical reaction caused by UV radiation [25, 26, 27, 28, 29, 30, 31]. Minimal dimensions of materials obtained by extrusion remain in the 1 mm range defined by the dimensions of the mold or nozzle. The obtained fresh tubes are sintered at elevated temperatures to increase their density, to remove the additives and to increase the strength and hardness of the material. Extrusion is the most widely applied top-down approach for preparation of metal oxide ceramic materials. It's cheap to apply the technology in macro scale. However, the method cannot be applied for the preparation of microtubes, which have an inner diameter below 100 μm as in addition of miniature nozzles (diameter 100-1000 μm), advanced precursors are also desired. For that, the precursor should be homogenous in nano scale containing no particles bigger than 1-2 μm. Moreover, the precursors should have suitable viscous-elastic properties to avoid the collapse of freshly extruded structures under the high surface energy of the precursor. All those requirements make the method too expensive to apply to produce tubes in micro scale. Therefore the extrusion method is in use for preparing tubes with rather large diameters (5-200 mm). Disadvantage of the method is that freshly pressed tubes are soft and difficult to handle in further processing [32].

Metal oxide microtubes can be milled out from larger size monoliths. It can be done by cutting mechanically or by using an electron or ion-source. This method enables preparing the tubes made of almost all metal oxide materials including their very hard monocrystalline forms. The drawback of the method is its costly nature as exact mechanics and cutting tools and working in high vacuum are needed.

The method to build up the tubes atom by atom or molecule by molecule as a result of self-formation processes is known as bottom-up approach for materials preparation. The tubes form as energetically most favoured structures. Diameter of the tubes is defined by the size of catalysing particles. The method is suitable for preparation of very small nanotubes in diameter range from 1 to 100 nm. The formation of tubes with a bigger diameter is energetically unfavoured as growth remains too low and the number of defects in the tube structure increases.

Widely-known method for the preparation of tubes is based on roll-up of thin layers of materials. The conditions have been suggested for self-formation of metal oxide ceramic tubes in micro-scale. For that, the selected substrate is coated with a metal oxide precursor. The tubes can roll up when the substrate is removed, which can be done by dissolution or mechanical cleaving. Roll-up process is supported by the tendency of materials to minimize their surface energy [33]. The parameters (length, wall thickness, and diameter) of the tubes are controlled by the length and thickness of the initial film piece and the selection of solvents. A drawback of the method is that the tubes which form have an open edge, wherefore they cannot be applied to pump liquids nor gasses under pressure.

Known method for preparation of different shape 3-D ceramic structures, including microtubes, is microstereolithography [34]. Process is controlled by using, e.g. a laser-beam. Structures are grown-up layer by layer. The method is rather expensive as it needs exact mechanics. As the final structures are achieved by growing them layer by layer, the process is also time consuming.

The use of sol-gel technology in preparation of metal oxide ceramic microtubes is known as a part of prior art. The function of sol-gel processing in those methods is to coat templates with thin metal oxide films [5, 6, 35].

The method to use sol-gel processes in preparation of metal oxide microtubes without using templates is known as a part of prior-art [36]. The process is carried out by using a precursor made from a mixture of Ti(i-OPr)₄ and 2-propanol. Viscosity of the mixture is grown into 10-30000 P range that is required for drawing fibres. Increased viscosity of precursor material is achieved when it is left in the vessel, open to air humidity, for 1-2 days. The material in contact with air humidity undergoes chemical processes which lead to growth and agglomeration of particles of neat Ti(i-OPr)₄, resulting in increased viscosity of the system. Fibres are pulled from the mixture 0.5-1.5 h prior to its final gelation. For pulling fibres, pulling speed 0.1-1 m/s is applied. More than 1.5 h prior to gelation, the viscosity is not suitable for pulling fibres due to too low viscosity (below 10 P). Pulling fibres from such a mixture is not possible as high surface tension of the matter leads to a collapse of the jets prior to their solidification when less time is left until final gelation of the mixture the viscosity grows too high (30000 P or more). This causes a break-up of the jets under cohesive forces as the material doesn't exhibit elongational behaviour when external forces are applied. Parameters of the method are defined by the concentration of solvents, acidity-alkalinity of mixture, air humidity, temperature and time.

For the preparation of microtubes (hollow fibres), it is needed to generate gas bubbles into the mixture prior to drawing the fibres. This could be done by mixing the solution intensively in the bulb with a rod for 5-10 minutes. The mixture is transformed into jets by using drawing or pressing through a nozzle or by using some combination thereof like extrusion or electrospinning. When electrospinning is applied, the material is pressed through the nozzle, whereafter it is additionally drawn by using electrostatic external forces. The tubes form when the bubbles which remain in the jet start to grow as a response to the decrease of the volume of the matter that is undergoing chemical processes. The bubbles grow and fuse together and finally form a hollow region in the centre of the structure.

The process for preparing tubes in this way is demonstrated on FIG. 2 and it is carried out as a result of following steps:
Bubbles are generated in the tube precursor material (viscosity 10-30000 P) prior to processing by using intensive mixing for 5-10 minutes.
Jets of the precursor are pulled into air. A solid shell forms on the surface of the jet as a result of chemical processes caused by air humidity. The cores of the jets remain liquid and exhibit viscous behaviour. Bubbles can move and increase inside the shell. Solidification process leads for a decrease of volume of the material. As the surface of the jet is covered by a rigid solid shell, the bubbles inside the shell start to grow along the axis of jet. The bubbles finally fuse together forming a hollow region inside the shell. Finally, viscosity starts to grow inside the shell, as well, fixing the bubbles along the fibre axis.

The method enables to prepare TiO₂ tubes which have outer diameters in the 50-200 μm and inner diameters in the 5-90 μm ranges.

Described process is technologically simple. Obtained tubes have optical quality and they are transparent, which proves nano scale structural homogeneity of the tube material. A drawback of the method is that it enables to prepare tubes with diameter in narrow region from 50 to 200 μm. Tubes with larger diameters crack during the thermal annealing process. Minimal diameter of the tubes is defined by the size of the bubbles. In addition, the solidification of jets less than 50 microns in diameter is too quick to fuse the bubbles together. It could be seen from illustrative images (FIG. 3) that hollow regions (tubes) inside the fibres are very short, no more than 0.2-2 mm. This is due to the high viscosity of the precursor liquid that inhibits the fusing of the bubbles into longer tubes. Wall thicknesses of the tubes vary in a large range from 5 to 50 μm. The method disclosed in this patent is a descendant of the described method [36].

### DISCLOSURE OF INVENTION

Current invention is an improved method for preparation of metal oxide microtubes. The formation of tubes in accordance with the current invention starts by formation of a solid shell on the surface of a viscous (10-30000 P) jet obtained by direct drawing or extrusion through a nozzle or by using any combination thereof. The solid content inside the precursor is in the form of metal alkoxide or metal oxo-alkoxide. The nature of chemical processes which lead to the formation of tubes is similar in both cases, being initiated by air humidity. The process differs from the prior art in the following:
Hollowing of the fibres is achieved by the selection of precursor composition: to achieve suitable viscosity for fibres pulling, a metal alkoxide (Hf, Zr, Ce, or metals from the lantanoid group in combination with etoxide, propoxide, iso-propoxide, butoxide, tert-butoxide, pentoxide etc.) are fully or partially converted into metal oxo-alkoxides as a result of a reaction with maximum 2 mole of water per 1 mole of neat alkoxide.
The precursors are used as highly concentrated solutions containing a minimum of 50% of solvents as corresponding alcohols (etanol, propanol, iso-propanol, butanol, tert-butanol, pentanol etc.), other alcohols, alkanes, bensen, cloroform etc.
Up to 0-25% of additives (compounds of rare earth metals, organic and anorganic materials, polymers, salts, carbon nanostructures, biomolecules and shells etc.) can be added to the precursor in order to modify properties of the precursor (viscous-elasticity, solidification speed etc.) or to add functionality to the final material (luminescent properties, bio-sensitivity, electronic- or ionic conductivity etc.)
Solidification of the jets is achieved as a result of chemical processes or evaporation of solvents from the surface of matter that lead to the formation of a soft shell on the surface, instead or rigid one.
When the precursors are processed into jets with diameters in the range of 5 to 500 μm in air the solidification starts by the formation of a rigid solid shell on the surface of the liquid jet. After that, the process does not proceed with homogeneous solidification of the matter as the oxide matter inside the shell is consumed in the thickening tube walls, while the organic content of the precursor is released and remains to fill the hollow region inside the shell. Therefore the tubes form filled with alcohol and solvents released during the chemical processes. Empty tubes are obtained when the liquid content is removed from the hollow region. That can be done by using evaporation or dissolving of the materials through the walls or the ends of the tube. Initial precursors can be converted into jets by using direct drawing, pressing them through a nozzle or by using extrusion, which combines them both: the material is pressed trough the nozzle and then drawn thinner using external forces like mechanical (fibre spinning) and electrostatic (electrospinning) forces. Extrusion processes enable pulling fibres in non-stop mode.

Using the method disclosed in the current patent following materials can be obtained:
Tubes that are chemically and mechanically stable in temperature range from 2-2000K.
Tubes that have outer diameter from 1-500 μm.
Tubes that have wall thickness in range from 0.3-200 μm.
Tubes, to which 0-10000 atmospheres overpressure can be applied to the inside or outside of the tubes respectively.
Tubes which are made of ion-conducting oxides like Y₂O₃ or Sc₂O₃ or doped ZrO₂, Gd₂O₃ or Ce₂O₃. The materials are ionically conductive at temperatures above 300 K, at least.
Light emitting tubes. Fluorescent properties are given to oxide materials by doping them with ions of rare-earth metals like Sm³⁺ or Eu²⁺, organic dyes or quantum nano-dots.
Transparent tubes with wave-guiding properties.

### BRIEF DESCRIPTION OF DRAWINGS

The present invention is illustrated with detailed Figures, where

FIG. 1 describes different steps of template method, which enables to prepare metal oxide microtubes by using fibre template as sacrificial substrate. The tubes are obtained when the template is removed from the material by dissolving or burning for example;

FIG. 2 describes the preparation of metal oxide microtubes in accordance to prototype of current patent;

FIG. 3 describes applications of the tubes prepared by applying the current patent;

FIG. 4 illustrates the microtube formed according to present invention.

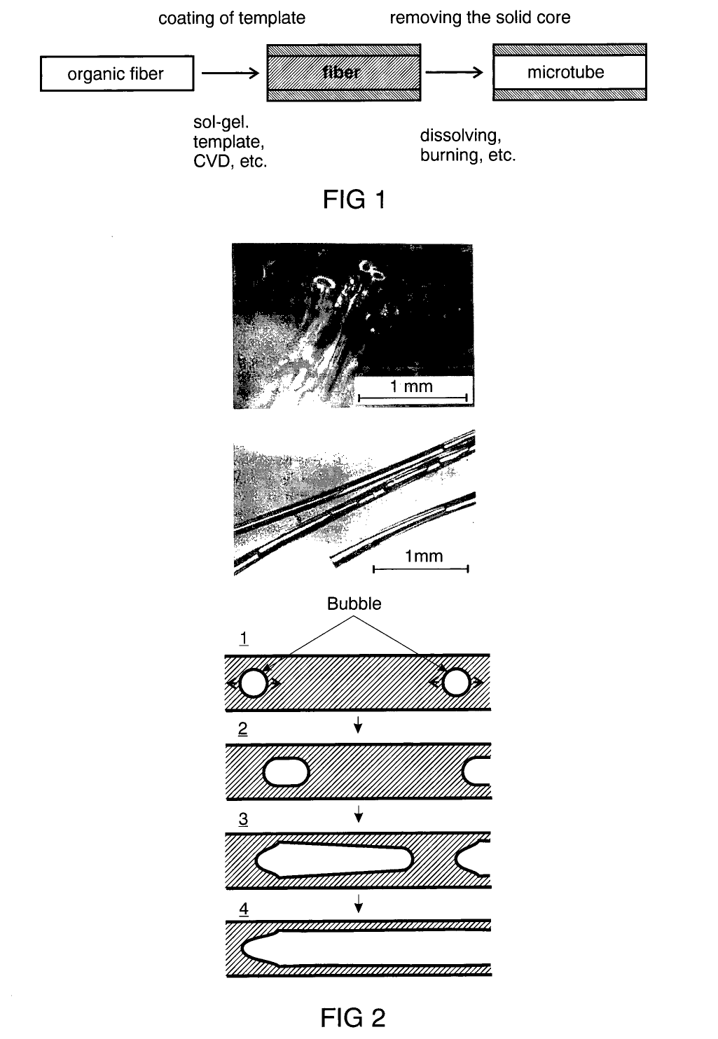

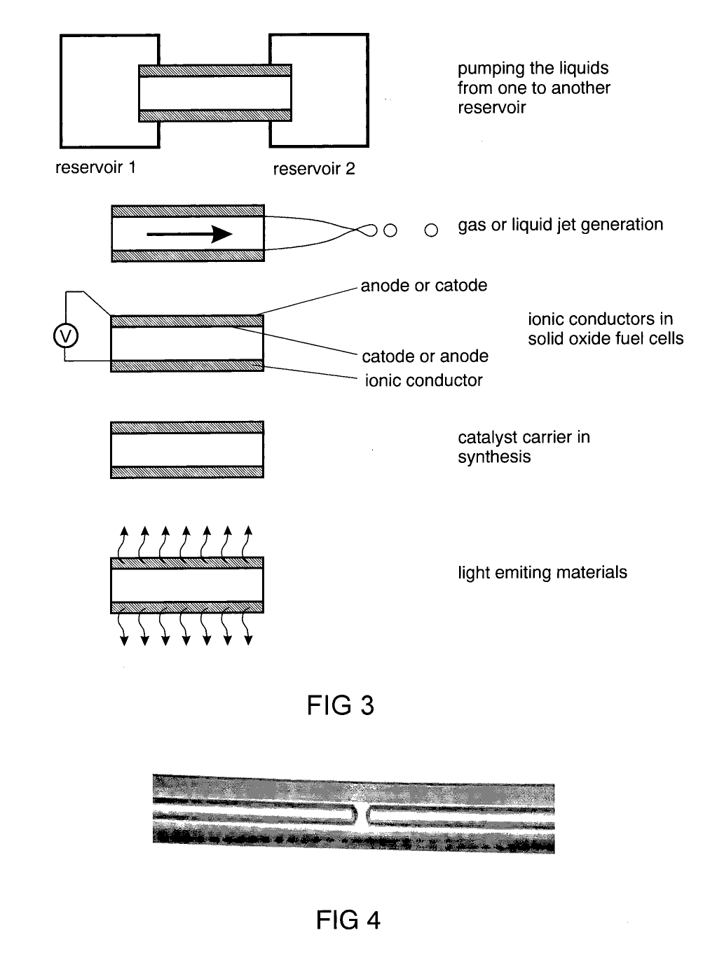

### BEST MODE FOR CARRYING OUT THE INVENTION

A precursor which is a mixture comprising metal alkoxides (for example Hf, Zr, Ce, Al, V alkoxides), metal-organic compounds (metals from the lantanoid group in combination with etoxide, propoxide, iso-propoxide, butoxide, tert-butoxide, pentoxide) or metal salts and a high boiling-point solvent, should have a viscosity in the range from 10 to 30000 P. To achieve named viscosity is used in the mixture the high boiling-point (boiling point above 150° C.) organic solvent. For preparation of the tubes the precursor is drawn or pressed into jets through nozzles by applying a pulling speed of 0.1-1000 m/s. When the viscosity of precursor is below 10 P then it is not possible to convert the material to the form of stable jets. When viscosity is higher than 30000 P then the jets start to break off due to cohesive forces as the materials do not exhibit any more elongational behaviour.

When directing the precursor material according to the present invention having viscosity from 10 to 30000 P into jets in a humid environment the surface of the jets starts to solidify by a polycondensation process, which leads to the formation of a three-dimensional network of precursor particles forming a rigid solid shell on the surface of the jet. The thickening of the rigid solid shell continues by consuming solid content of the precursor material to form a thicker shell wall until a microtube is formed, which is filled by a liquid phase of released organic substances contained in the precursor material. Thereafter the microtubes are aged in a gaseous environment for removal of the organic substances from the hollow core thereby densifying the wall material of the microtube. To obtain a stable tetragonal or cubic structure of microtube material the microtubes are heated after at 500-1000° C. for at least 2 hours. In alternative embodiment to stabilise the tetragonal or cubic phase of the material during forming of the microtubes the stabilizing compound is added to the precursor material before preparing the microtubes The stabilising compound is selected for example from compounds comprising metal from the third group of the periodic table, like Y or Sc. In addition the precursor material can be doped with a fluorescent compound before preparing the microtubes where the fluorescent compound is selected for example from the group comprising rare earth elements, quantum nano-dots or organic molecules, or a mixture thereof.

Only jets in the diameter range from 1-500 μm are used in preparation of the tubes. These jets can be prepared by using direct drawing, extrusion, electrospinning etc. Smaller diameter jets convert into fibres, not tubes, or collapse under the relatively high surface tension of the jets. Jets with larger diameters crack during the transition into tubes. Transformation of the jets into solid metal oxide microtubes is carried out in humid liquid or gas environment as a result of a reaction between precursor material and water vapour.

### Example 1

### Yttrium-Stabilized Zirconium Oxide (YSZ) Microtubes Preparation

Mixture of 5 g Zr(OBu)₄ and 5 g 1-butanol is made in a 100 ml reaction bulb. After 5 min of vigorous stirring, 5% Y(NO₃)₃ solution in 1-butanol is added dropwise into the solution. Addition of yttrium is carried out until the solution reaches atom ratio Y/Zr in range from 1/100 to 1/3. Subsequently, water, acidified by two drops (15-20 mg) of 35% HCl water solution is mixed into the solution as a solution in 10-15 ml 1-butanol. Water solution is added drop-by-drop during 10 minutes, stirring the solution vigorously at the same time, until water/butoxide molar ratio up to 0,9 is reached. After mixing all the components, the solvents are evaporated from the mixture and a precursor material ready for use in further experiments is obtained. Viscosity of obtained precursor remains in the range of 500 to 1000 P.

To prepare the tubes, the precursor is pulled into jets with length at least 0.5 cm by using a form of direct drawing. Surface of the jets solidifies in 0.001-1 second at 22° C. when relative air humidity is between 20-30%. Tube formation (formation of tube walls) continues for 5-10 minutes after fiber pulling. After that the tubes are left to age for two days in air as a first step of post-processing. Aging is needed to remove the organic substances from the core and to densify the solid material. For final densification of the material, the tubes are heated at 800-1000° C. Heating is important to obtain a stable tetragonal or cubic structure of material. Obtained microtubes are optically homogenous (applicable as waveguides), ion-conductive at temperatures above 300° C., mechanically and chemically stable. Tensile strength of the tubes ranges from 500 to 1000 MPa. Obtained tubes are stable in applications carried out in temperature range from 2-1500 K.

### Example 2

### YSZ Microtubes Preparation from Zr(OPr)₄

Mixture of 5 g Zr(OPr)₄ and 5 g 1-propanol is made in a 100 ml reaction bulb. After 5 min of vigorous stirring, 5% Y(NO₃)₃ solution in 1-propanol is added dropwise into the solution. Addition of yttrium is carried out until reaching atom ratio Y/Zr in range from 1/100 to 1/3. Subsequently, water, acidified by two drops (15-20 mg) of 35% HCl water solution, is mixed into the solution as a solution in 10-15 ml 1-propanol. Water solution is added drop-by-drop during 10 minutes, stirring the solution vigorously at the same time, until a water/butoxide molar ratio up to 0,9 is reached. After mixing all the components, the solvents are evaporated from the mixture and a precursor material ready for use in further experiments is obtained. Viscosity of obtained precursor remains in the range of 500 to 1000 P.

The preparation of tubes from the precursor material and post-processing of tubes are carried out as described in Example 1. Properties of obtained tubes are similar to those described in Example 1.

### Example 3

### Tube Preparation from Hafnium Oxide

Mixture of 5 g Hf(OBu)₄ and 5 g 1-butanol is made in a 100 ml reaction bulb. Subsequently, water, acidified by two drops (15-20 mg) of 35% HCl water solution, is mixed into the solution as a solution in 10-15 ml 1-butanol. Water solution is added to the mixture drop-by-drop during 10 minutes, stirring the solution vigorously at the same time until a water/butoxide molar ratio up to 0.7 is reached. After mixing all the components, the solvents are evaporated from the mixture and a precursor material ready for use in further experiments is obtained. Viscosity of obtained precursor remains in the range of 500 to 1000 P.

The preparation of tubes from precursor material and post-processing of tubes are carried out as described in Example 1. Obtained microtubes are optically homogenous, mechanically and chemically stable. Tensile strength of tubes ranges from 50 to 1000 MPa.

### Example 4

### Tube Preparation from Cerium Oxide

In order to prepare CeO₂ tubes, a material based on pure, untreated Ce(OBu)₄ is used. The use of Ce(OBu)₄ directly in experiments is possible as this alkoxide possesses suitable viscous-elastic properties for jet pulling, for which no additional polymerisation by adding water is necessary.

The preparation of tubes from the precursor material is carried out as described in example 1. For final densification of material, the tubes are heated at a temperature between 600-900° C. Heating is important to transform the material into stable nanocrystalline form.

### Example 5

### YSZ Microtubes Preparation in Liquid Environment

Precursor material is prepared as described in Example 1. To prepare the tubes, precursor is pulled into jets in air by using a direct drawing method. The surface of the jets solidifies in 0.001-1 second at 22° C. when relative air humidity is between 20-30%. 10 seconds after jet pulling, the fibres are submerged into a dimethyl sulfoxide (DMSO) solution, containing 2-3% of water to induce hollowing of the fiber. Tubes form within 10 minutes after submerging as a result of reactions with the water in the solution. Reactions end within 1 h, after which the tubes are left to age for two days in air at temperature 22° C. as a first step of post-processing. Aging is needed to remove organic materials from the hollow core and to increase the density of the materials. For final densification of the material, the tubes are heated at 800-900° C. Heating is important to obtain a stable tetragonal or cubic structure of the material. Obtained microtubes are optically homogenous (applicable as waveguides), ion-conductive at temperatures above 300° C., mechanically and chemically stable. Tensile strength of tubes ranges from 50 to 1000 MPa.

### Example 6

### Microtubes Preparation by Using Extrusion Technique

Precursor material is prepared as described in examples 1-5. Jets are generated by pressing the precursor material through a nozzle with a 10-500 μm inner diameter. The resulting jet is spinned on the drum or stretched by gravity. After that the jets are exposed to a humid environment so that tubes' formation can proceed as described in examples 1-5. Post-processing of tubes (ageing and heating) is carried out as described in examples 1-5. The tubes can, for example, be applied in any of the following applications:
As constructing materials in a temperature range from 2-2000 K.
As pipes to pump liquids or gasses from one reservoir to another, as nozzles to generate liquid or gas jets or as spray nozzles to generate liquids droplets. The tubes can be applied for these purposes in the temperature range from 2-2000 K and under a pressure difference of 0-10000 atm. between the inside and outside of the tube.
As ionic-membranes to separate electrode materials from each other to avoid electron- or hole-type leakage from electrode to electrode as the inner and outer surfaces of the tubes, which are ionically (O²⁻) conductive, are fully separated from each other in the case of tubular geometry. The tube material works as ionic-membrane because even when the electron- or hole-type electrical conduction between the electrodes is prohibited, ionic conduction based on (O²⁻) is still supported. Electrodes that can also catalyze decomposition of gasses like O₂, CH₄, H₂, C₂H₆ etc. can be deposited on the surface of the tubes by using sol-gel technology, atomic layer deposition (ALD), chemical vapour deposition or other known coating methods. Coating the inner and outer surface of the tube with layers that are able to decompose these gasses, different devices can be constructed, for example devices that generate electrical voltage and can therefore be used as gas detectors.
As stable substrates for catalysing particles. This application is supported by high surface area per unit mass.
As light-emitters as the tube materials can easily be doped with light emitting additives. The light can be generated inside the tubes by using radiation-, electric- or some other kind of excitation.

### REFERENCES

1. Chu, M; Huang, J, Preparation and characterization of fluorescent microtubes with high length/diameter ratios SMART MATERIALS AND STRUCTURES 18 (2009)
2. Imai, H; Matsuta, M; Shimizu, K; Hirashima, H; Negishi, N; PREPARATION OF TiO2 FIBERS WITH WELL-ORGANIZED STRUCTURES, JOURNAL OF MATERIALS CHEMISTRY, 2000, 10, 2005-2006
3. Ono, Y.; Nakashima, K.; Sano, M.; Kanekiyo, Y.; Inoue, K.; Hojo, J.; Shinkai, S., CHEM COMMUN., 1998, 1477
4. Shenton, W.; Douglas, T.; Young, M.; Stubbs, G.; Mann, S., ADV. MATER., 1999, 11, 253
5. Ono, Y.; Kanekiyo, Y.; Inoue, K.; Hojo, J.; Nango, M.; Shinkai, S., CHEM. LETT., 1999, 475
6. Miyaji, F.; Tatematsu, Y.; Suyuma, Y., J. CERAM. SOC. JPN., 2001, 109, 924
7. Kikuta, K.; Kubota, C.; Takeuchi, Y.; Ito, Y.; Usui, T.; Fabrication and characterization of microtubular and flattened ribbed SOFCs prepared by the multi-dip coating and co-firing. JOURNAL OF THE EUROPEAN CERAMIC SOCIETY, 30 (2010) 927-931
8. Bao, J; Xu, D; Zhou, Q; Xu, Z; Feng, Y; Zhou, Y; CHEM. MATTER., 14 (2002) 4709
9. Yang, D; Qi, L; Ma, J; Hierarchically ordered networks comprising crystalline ZrO2 tubes through sol-gel mineralization of eggshell membranes, JOURNAL OF MATERIALS CHEMISTRY, 2003, 13, 1119-1123
10. Yang, D; Qi, L; Ma, J; ADV. MATER., 2002, 14, 1543
11. Li, K F; Wang, L H; Liu, W D, et al. Ionic liquid-assisted sacrificial templating route to hollow CdMoO4 microtubes JOURNAL OF THE CERAMIC SOCIETY OF JAPAN vol 118(1375) (ISI: ceramic microtubes)
12. Gibot B and Vix-Guteri C TiO₂ and [TiO₂/beta-SiC] microtubes prepared from an original process JOURNAL OF THE EUROPEAN CERAMIC SOCIETY 27(5) 2007 2195-2201
13. Rao, C. N. R.; Satishkumar, B. C.; Govindaraj, A; CHEM. COMMUN., 1997, 1581
14. Prabhakaran, K; Raghunath, S; Melkeri, A, et al. Preparation of PZT Microtubes by Slip Casting on Vermicelli, Followed by In Situ Polymerization INTERNATIONAL JOURNAL OF APPLIED CERAMIC TECHNOLOGY vol 7(3) 409-413. (ISI ceramic microtubes)
15. Li, M; Wang, D; Ding, S; Ding, Y; Liu, J; Liu, Z; APPLIED SURFACE SCIENCE 2007 253 4161
16. Hoffman, W. P.; Phan, H. T.; Wapner, P. G, The far-reaching nature of microtube technology, MATER. RES. INNOV., 2, 87-96, 1998
17. Motojima, S.; In-Wang, W.; Chen, X., Preparation and Properties of Microcoils and Microtubes of NbC/C/NbC˜NbC by Vapor Phase Metallizing of the Regular Carbon Microcoils, MATER. RES. BULL., 35, 1517-24, 2000
18. Sun, Y; Fuge, G M; Fox, N A; Riley, D J; Ashfold, M N R; ADVANCED MATERIALS 17 2477, 2005
19. Cheng, H; Cheng, J; Zhang, Y; Wang, Q J; CRYST. GROWTH, 299, 34 2007
20. Lovetta, M; Cannizzaroa, C; Daheronc, L; Messmera, B; Vunjak-Novakovice, G; Kaplana, D L; BIOMATERIALS 28 5271, 2007
21. Giordano, C; Todaro, M T; Palumbo, M; Blasi, L; Errico, V; Salhi, A; Qualtieri, A; Gigli, G; Passaseo, A; De Vittorio, M; MICROELECTRON. ENG. 85 1170, 2008
22. Yoo, J. H.; Gao, W, Near-net ceramic micro-tubes fabricated by electrophoretic deposition process, INTERNATIONAL JOURNAL OF MODERN PHYSICS B, 2003, 17, 1147-1151
23. Poehnitzseh, S.; Grathwohl, G.; The Development of the Central Pore Canal during Sintering of Ceramic Capillaries, PRAKT. METALLOGR., 37 (11) 608-18, 2000
24. Wang, X.; Huang, B.; Wang, Z.; Qin, X.; Zhang, X.; Dai, Y.; Whangbo. M-H., Synthesis of Anatase TiO₂ Tubular Structures Microcrystallites with a High Percentage of {001} Facets One-Step Hydrothermal Template Process, CHEM. EUR. J., 2010, 16, 7106-7109
25. Suzuki, T; Funahashi, Y; Hasan, Z; Yamaguchi, T; Fujishiro, Y; Awano, M; FABRICATION OF NEEDLE-TYPE MICRO SOFC'S FOR MICRO POWER DEVICES, Electrochemistry Communications 10 (2008) 1563-1566
26. Yamaguchi, T.; Shimizu, S.; Suzuki, T.; Fujishiro, Y.; Awano, M., Fabrication and characterization of high performance cathode supported small-scale SOFC for intermediate temperature operation, ELECTROCHEMISTRY COMMUNICATIONS, 10 (2008) 1381-1383
27. Du, Y. H.; Sammes N. H., Fabrication and properties of anode-supported tubular solid oxide fuel cells, JOURNAL OF POWER SOURCES, 2004, 136, 66-71
28. Colombo, P.; Perini, K.; Bernardo, E.; Capelletti, T.; Maccagnan, G., Ceramic Microtubes from Preceramic Polymers, J. AM. CERAM. SOC., 86 [6] 1025-27 (2003)
29. Yamaguchi, T.; Wet preparation and characterization of ScSZ thin film electrolyte on micro-cathode supports, JOURNAL OF THE CERAMIC SOCIETY OF JAPAN, 117[2] 139-142 2009
30. Tan, X.; Yin, W.; Meng, B.; Meng, X.; Yang, N.; Ma, Z., Preparation of electrolyte membranes for micro tubular solid oxide fuel cells, SCIENCE IN CHINA SERIES B: CHEMISTRY, 51, 808-812, 2008
31. Yang, N T; Tan, X Y; Ma, Z F, et al. Fabrication and Characterization of Ce0.8Sm0.2O1.9 Microtubular Dual-Structured Electrolyte Membranes for Application in Solid Oxide Fuel Cell Technology JACS 92 (11) 2544-2550
32. Suzuki, T.; Yamaguchi, T.; Fujishiro, Y.; Awano, M.; Fabrication and characterization of micro tubular SOFCs for operation in the intermediate temperature. JOURNAL OF POWER SOURCES, 2006, 160, 73-77
33. Akiyama, M.; Shobu, K.; Xu, C-N.; Nonaka, K.; Watanabe, T., Ceramic microtubes self-formed at room temperature that exhibit a large bending stress, JOURNAL OF APPLIED PHYSICS, 88, 7, 2000
34. Zhang, X; Jiang, X N; Sun, C Micro-stereolithography of polymeric and ceramic microstructures SENSORS AND ACTUATORS A-PHYSICAL 77 (2) 149-155
35. Peng, T.; Yang, H.; Dai, K.; Nakanishi, K.; Hirao, K., Sol-gel Template Synthesis of Aluminum Oxide Microtubules, ADVANCED ENGINEERING MATERIALS, 2004, 6, 241-244
36. Aizawa M., Nakagawa Y., Nosaka Y., Fujii N., Miyama H. Preparation of hollow TiO₂ fibres, Journal of Non-Chrstalline Solids 124 (1990) 112-115

1. A method for preparing metal oxide microtubes from a precursor material, which is a mixture comprising metal alkoxides, metal-organic compounds or metal salts and a high boiling-point solvent, the method comprising the steps of
a) selecting the high boiling-point solvent material, concentration and amount of said material to achieve viscosity of the precursor material from 10-30000 P,
b) directing the precursor material into jets in a humid environment, wherein the surface of the jets starts to solidify by a polycondensation process, which leads to the formation of a three-dimensional network of precursor particles forming a rigid solid shell on the surface of the jet, whereafter
c) the thickening of the rigid solid shell continues by consuming solid content of the precursor material to form a thicker shell wall until a microtube is formed, which is filled by a liquid phase of released organic substances contained in the precursor material, thereafter
d) aging the microtubes in a gaseous environment to remove the organic substances from the hollow core thereby densifying the wall material of the microtube.

2. The method according to claim 1, wherein the microtubes are heated after step c) at 500-1000° C. for at least 2 hours to obtain a stable tetragonal or cubic structure of microtube material.

3. The method according to claim 1, wherein the metal alkoxide is selected from the group consisting of Hf, Zr, Ce, Al, V alkoxides or metals from the lantanoid group in combination with etoxide, propoxide, iso-propoxide, butoxide, tert-butoxide, pentoxide.

4. The method according to claim 1, wherein the length of the obtained jet is at least 0.5 cm.

5. The method according to claim 1, wherein the formation of the microtubes takes place in the temperature range of −50-200° C. and the relative humidity of the environment is 1-100%.

6. The method according to claim 1, wherein a stabilizing compound is added to the precursor material before preparing the microtubes to stabilise the tetragonal or cubic phase of the material.

7. The method according to claim 6, wherein the stabilizing compound is selected from compounds comprising metal from the third group of the periodic table.

8. The method according to claim 1, characterized in that the precursor material is doped with a fluorescent compound before preparing the microtubes.

9. The method according to claim 8, wherein the fluorescent compound is selected from the group consisting of rare earth elements, quantum nano-dots, organic molecules and mixtures thereof.

10. Microtubes prepared according to the method described in claim 1 for light source applications.

11. Microtubes prepared according to the method described in claim 1 in/as ion-conducting membranes to separate electron conducting materials in high temperature from 500 K devices.

12. Optical waveguides comprising microtubes prepared according to the method described in claim 1.

13. Microtubes prepared according to claim 1 for piping liquid content in microfluidic cells.

14. Microtubes prepared according to the method described in claim 1 in applications having a pressure difference up to 10,000 atm applied between inside and outside of the microtubes.

15. Microtubes prepared according to the method described in claim 1 in applications at temperatures up to 1500° C.

16. The method according to claim 2, wherein the metal alkoxide is selected from the group consisting of Hf, Zr, Ce, Al, V alkoxides or metals from the lantanoid group in combination with etoxide, propoxide, iso-propoxide, butoxide, tert-butoxide, pentoxide.

17. The method according to claim 2, wherein the length of the obtained jet is at least 0.5 cm.

18. The method according to claim 2, wherein the formation of the microtubes takes place in the temperature range of −50-200° C. and the relative humidity of the environment is 1-100%.

19. The method according to claim 2, wherein a stabilizing compound is added to the precursor material before preparing the microtubes to stabilise the tetragonal or cubic phase of the material.

20. The method according to claim 7, wherein the stabilizing compound is Y or Sc.
